(19) United States
(12) Patent Application Publication
(10) Pub. No.: US 2008/0305844 A1
(43) Pub. Date: Dec. 11, 2008

(54) DETERMINING GAME PERFORMANCE STATISTICS WITHOUT REVEALING SPECIFIC GAMING METER DATA

(75) Inventors: Dwayne A. Davis, Reno, NV (US); Michael M. Oberberger, Reno, NV (US)

Correspondence Address: Weaver Austin Villeneuve & Sampson LLP - IGT;Attn: IGT, P.O. Box 70250, Oakland, CA, 94612-0250, US

(73) Assignee: IGT, Reno, NV (US)

(21) Appl. No.: 11/759,362

(22) Filed: Jun. 7, 2007

(51) Int. Cl. G06F 19/00

(52) U.S. Cl. 463/1

(57) ABSTRACT

In one embodiment, a system to determine relative performance data of a gaming machine may have a memory having a database stored therein, a processor configured to obtain a relative performance value determined by confidential delta meter data and confidential gross meter data, transform the relative performance value to a transformed performance value, wherein the transformed performance value may be determined by multiplying the relative performance value with a previous transformed performance value, and compile the transformed performance value in the database, wherein the confidential delta meter data and confidential gross meter data are not revealed from the relative performance value.

### FIELD OF THE INVENTION

The present disclosure relates generally to determining gaming machine performance. More particularly, the present disclosure relates generally to determining gaming machine performance without revealing specific gaming meter data.

### BACKGROUND OF THE INVENTION

Determining or evaluating the performance of gaming machines is difficult as casinos are reluctant to provide specific gaming meter data. Casinos are reluctant to release the information because it reveals confidential financial data about their operations. For example, Casino A may have a bank of Wheel Of Fortune™ gaming machines that are successful because they are positioned in a high-traffic area. Casino B may also have a bank of the same gaming machines, but the machines are non-performing because they are positioned in a less visible area of the casino. Casino A would not want to share confidential financial information about the success of their gaming machines for fear that Casino B would move their machines to a more visible area. This may result in Casino A losing players to Casino B.

Unfortunately, specific gaming meter data could provide the most accurate data for gauging the performance of the gaming machine. Currently, the only other metric for gauging gaming machine performance is soft data based on subjective observation and analysis of the games, typically provided by slot crews, marketing, and sales information. There is no method in which to gauge gaming machine performances without the use of specific gaming meter data.

### OVERVIEW

The present invention provides for a system and method to determine the performance of a gaming machine without revealing specific gaming meter data. In one embodiment, a system to determine relative performance data of a gaming machine may have a memory having a database stored therein, a processor configured to obtain a relative performance value determined by confidential delta meter data and confidential gross meter data, transform the relative performance value to a transformed performance value, wherein the transformed performance value may be determined by multiplying the relative performance value with a previous transformed performance value, and compile the transformed performance value in the database.

In another embodiment, a method for determining relative performance data of a gaming machine may comprise receiving a relative performance value determined by confidential delta meter data and confidential gross meter data, transforming the relative performance value to a transformed performance value, wherein the transformed performance value is determined by multiplying the relative performance value with a previous transformed performance value, and plotting the transformed performance value on a performance graph.

In yet another embodiment, a method may comprise receiving raw meter data from a wager gaming machine, and applying a first operation to the raw meter data to remove confidential data, thereby producing relative performance data.

The present invention provides other hardware configured to perform the methods of the invention, as well as software stored in a machine-readable medium (e.g., a tangible storage medium) to control devices to perform these methods.

These and other features will be presented in more detail in the following detailed description of the invention and the associated figures.

### BRIEF DESCRIPTION OF THE DRAWINGS

The accompanying drawings, which are incorporated into and constitute a part of this specification, illustrate one or more example embodiments and, together with the description of example embodiments, serve to explain the principles and implementations.

In the drawings:

FIG. 1 illustrates a graph of the gross meter data of Table 1.

FIG. 2 illustrates a graph of the delta data obtained from the gross meter data.

FIG. 3 illustrates a graph of the relative performance data.

FIG. 4 illustrates a graph of the transformed performance data.

FIG. 5 illustrates a graph of the delta data for a bank of gaming machines.

FIG. 6 illustrates a graph of the relative performance data for a bank of gaming machines.

FIG. 7 illustrates a graph of the transformed performance data for a bank of gaming machines.

FIG. 8 illustrates an example embodiment of a gaming machine.

FIG. 9 illustrates an example embodiment of a network topology.

FIG. 10 is a block diagram of a simplified communication topology.

### DESCRIPTION OF EXAMPLE EMBODIMENTS

Embodiments are described herein in the context of determining game performance statistics without revealing specific gaming meter data. The following detailed description is illustrative only and is not intended to be in any way limiting. Other embodiments will readily suggest themselves to such skilled persons having the benefit of this disclosure. Reference will now be made in detail to implementations as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

The components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

The present invention provides for a system and method to determine the performance of a gaming machine without revealing specific gaming meter data. Determining the performance of gaming machines may assist in evaluating whether the gaming machine is performing or non-performing, or performing above or below some average or other statistical measure in relationship to data derived from other gaming machines. The data may also be used to evaluate features that are common in performing and/or non-performing gaming machines to determine what players like or do not like. This may help when developing different games, bonuses, and the like. Additionally, the data may be helpful in evaluating the need to develop different versions of the games and/or develop different games altogether. This may be beneficial to casinos because the data may allow them to obtain successful games early and avoid non-performing games.

Moreover, the data may help to time the release of new games and/or versions of current games. It would be helpful to determine when to release new games and/or versions to build upon the success of the previous game rather than trying to build upon a game that is no longer popular. There are gaming machines that start off strong and are popular for a period of time, but then quickly becomes non-performing since players become bored with the game. Other games start off strong but are replaced with another version of the game just as the previous gaming machine becomes less popular. These new versions or games are referred to as “legs.” The legs are released to keep the interest of the players and build upon the success and/or interest of the previous versions so that the gaming machine is played at a steady pace and does not become non-performing.

Gaming meter data may be used to analyze and gauge the relative performance of a gaming machine. A delta value, or an amount of change, may be calculated from the meter value obtained from the previous day. The delta value may then be divided by the previous day's delta value to produce a relative performance value. If the previous day's delta value is zero, it may be an indication that the gaming machine was not played. In such situations, the last non-zero delta value may be used as the previous day's delta value.

For exemplary purposes only, and not intended to be limiting, the following data on Table 1 may be used to illustrate an example embodiment. “Data” as used herein refers to a group of measurements or values and “value” refers to a single numerical quantity.

TABLE 1

| | Gross | | Relative | Transformed |
|---|---|---|---|---|
| Day | Meter | Delta | Performance | Performance |
| 1 | 49 | 49 | 0.00 | 1.00 |
| 2 | 128 | 79 | 1.61 | 1.61 |
| 3 | 159 | 31 | 0.39 | 0.63 |
| 4 | 211 | 52 | 1.68 | 1.06 |
| 5 | 292 | 81 | 1.56 | 1.65 |
| 6 | 327 | 35 | 0.43 | 0.71 |
| 7 | 463 | 136 | 3.89 | 2.78 |
| 8 | 566 | 103 | 0.76 | 2.10 |
| 9 | 765 | 199 | 1.93 | 4.06 |
| 10 | 971 | 206 | 1.04 | 4.20 |
| 11 | 1272 | 301 | 1.46 | 6.14 |
| 12 | 1430 | 158 | 0.52 | 3.22 |
| 13 | 1502 | 72 | 0.46 | 1.47 |
| 14 | 1517 | 15 | 0.21 | 0.31 |
| 15 | 1517 | 0 | 0.00 | 0.00 |
| 16 | 1592 | 75 | 5.00 | 1.53 |
| 17 | 1772 | 180 | 2.40 | 3.67 |
| 18 | 1974 | 202 | 1.12 | 4.12 |
| 19 | 2218 | 244 | 1.21 | 4.98 |
| 20 | 2500 | 282 | 1.16 | 5.76 |
| 21 | 2649 | 149 | 0.53 | 3.04 |

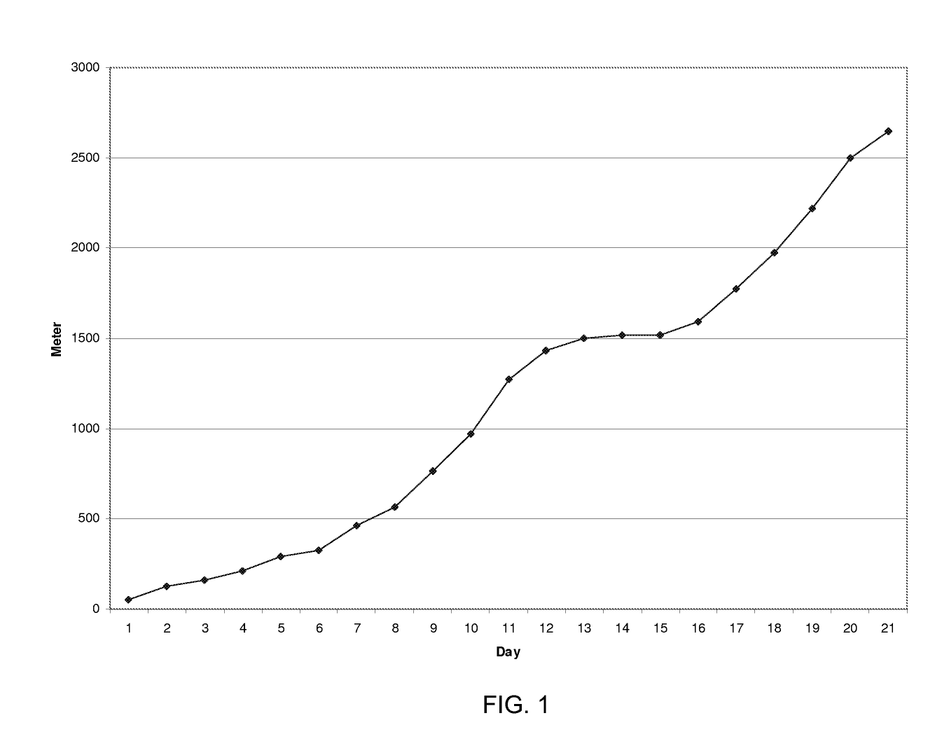

In Table 1, gaming data was obtained for days 1-21. FIG. 1 illustrates a graph of the gross meter data of Table 1. For days 1-21, gross meter data for the number of coins-in for a gaming machine may be obtained. Thus, on day 1, 49 coins were inserted into the gaming machine and on day 2, 79 coins were inserted. As can be seen in FIG. 1, the gaming machine generally gains in popularity from days 1-12, slows from day 12-16, and increases again in popularity from days 16-21. This information would be valuable to determine whether a gaming machine was performing or non-performing and for any of the other reasons discussed above. However, the gross meter data may be considered confidential information that casinos are reluctant to share.

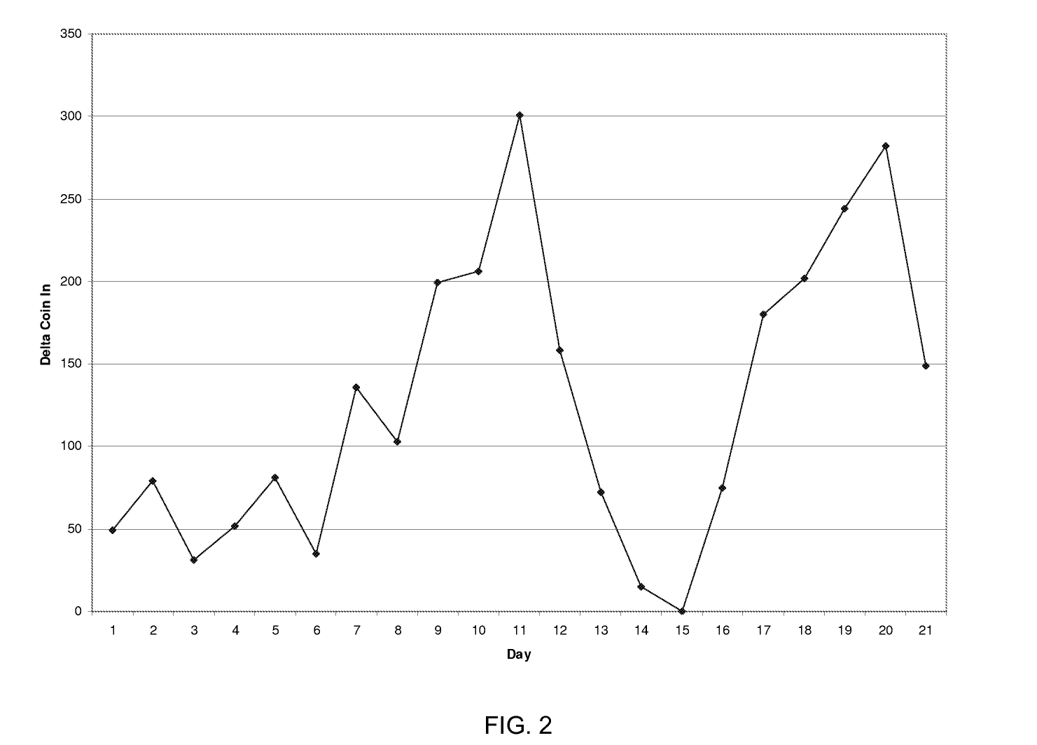

FIG. 2 illustrates a graph of the delta data obtained from the gross meter data. A delta value may be calculated by subtracting the previous day's gross meter value from the current gross meter value:

Δ_{d}=GM_{d}−GM_{d-n} (1)

wherein: Δ_{d} is the current delta value
GM_{d} is the current gross meter value
GM_{d-n} is the previous day's gross meter value
n is an integer

FIG. 2 may provide another view of the graph of the gross meter data. The delta data may provide information on how the machine performs on a day to day basis. Similar to FIG. 1, the data illustrates a rise in game play from days 1-12, a decrease in days 13-16, and another rise in days 17-21. This information may also be valuable to determine whether a gaming machine was performing or non-performing and for any of the other reasons discussed above. However, the delta data may still provide financial information about the gaming machine and may therefore be considered confidential information that casinos are reluctant to share.

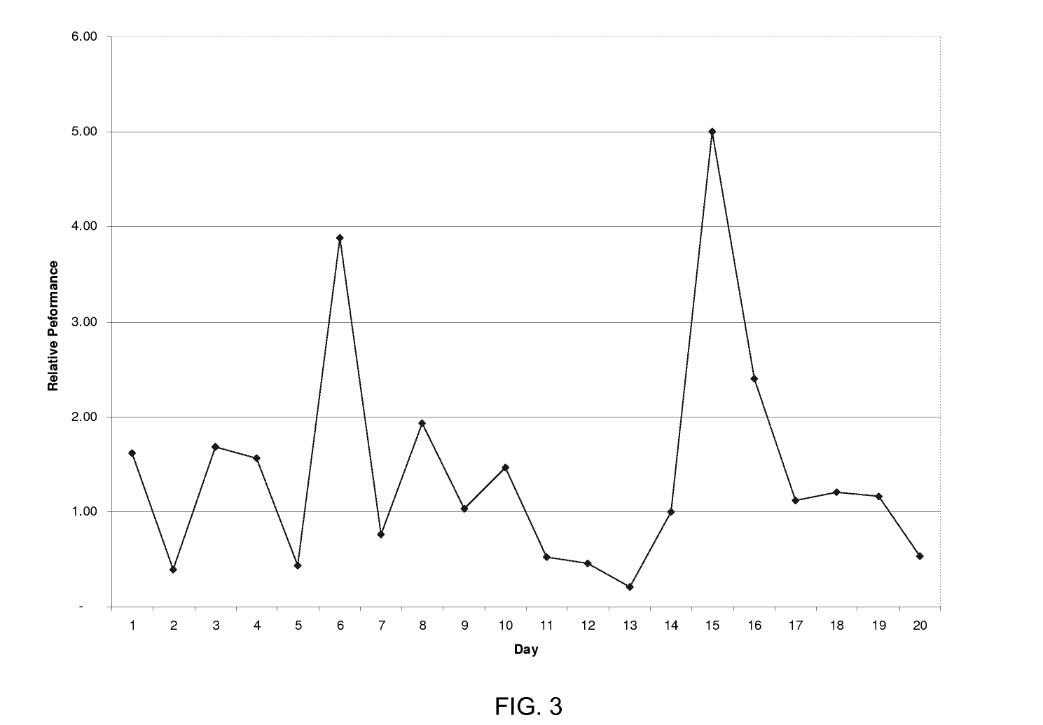

FIG. 3 illustrates a graph of the relative performance data. A relative performance value may be calculated from the current delta meter value divided by the previous non-zero delta meter value:

$${R}_{d} = \frac{{Δ}_{d}}{{Δ}_{d - n}} \qquad ( 2 )$$

wherein: R_{d} is the current relative performance value
Δ_{d} is the current delta value
Δ_{d-n} is the previous day's non-zero delta value

If the previous day's delta value is zero, another previous day's delta value may be used until the delta value is greater than zero. For example, as illustrated in Table 1, on day 15, the delta value is 0. Thus, the delta value from day 14 may be used to calculate the relative performance value. In one embodiment, to calculate the relative performance value, at least three gross meter values are used to derive the two delta values Δ_{d}, Δ_{d-n} above.

As can be seen in FIG. 3, the relative performance data graph does not look like the delta value graph of FIG. 2. Furthermore, no confidential or financial data about the gaming machine is revealed from the relative performance data. As such, the relative performance data may be provided to third parties outside the casino without revealing the confidential information, such as financial data.

It may now be known that other operations may be performed to the raw meter data to remove the confidential information or data to obtain relative performance data. For example and not intended to be limiting, the relative performance value may be calculated by:

$${R}_{d} = \frac{M * {Δ}_{d}}{N * {Δ}_{d - n}} \qquad ( 3 )$$

wherein R_{d} is the current relative performance value
Δ_{d} is the current delta value
Δ_{d-n} is the previous day's non-zero delta value
M and N are constants and/or variables

M and N may be any arbitrary constant and/or variable. Alternatively, M and N may be variables that may depend upon the raw meter values, delta values, or any other variables. Multiplying the delta values by an arbitrary constant and/or variable may generate a relative performance value in which no confidential data will be revealed.

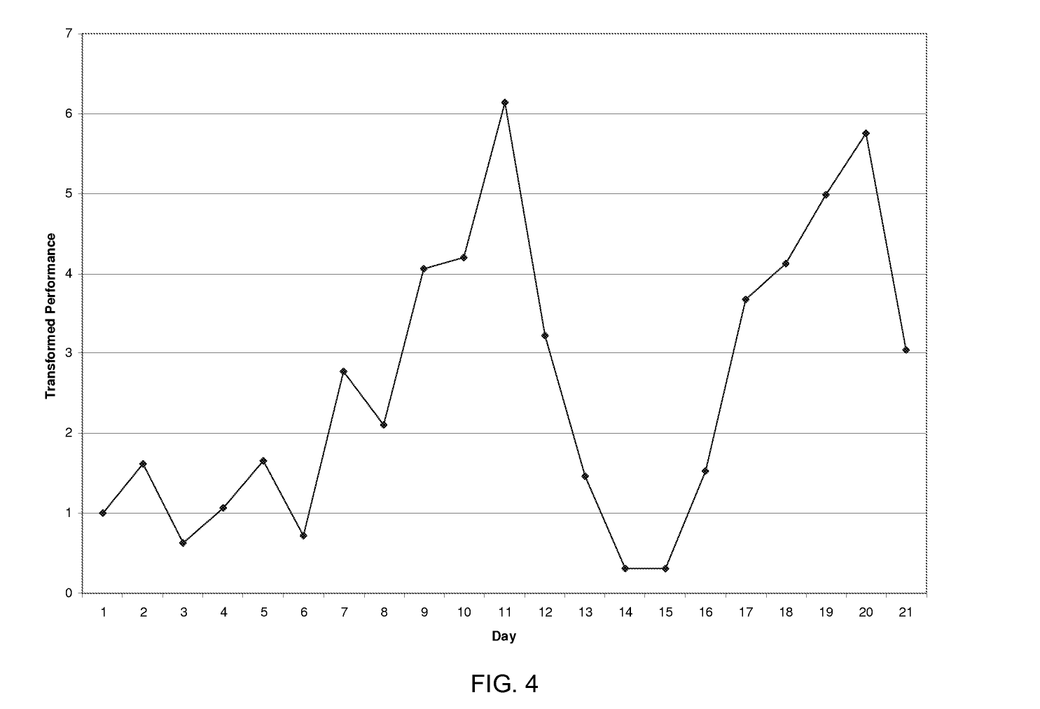

FIG. 4 illustrates a graph of the transformed performance data. A transformed performance value may be calculated by multiplying the current relative performance value by the previous non-zero transformed performance value:

T_{d}=R_{d}*T_{d-n} (4)

wherein: T_{d} is the current transformed performance value
R_{d} is the current relative performance value
T_{d-n} is the previous non-zero transformed performance value

If the previous day's transformed performance value is zero, another previous day's transformed performance value may be used until the transformed performance value is greater than zero.

The transformed performance data graph may be similar to the delta data graph of FIG. 2 as it may accurately represent the slopes for each graph segment from the delta data graph of FIG. 2. However, the scale of each graph is different and confidential information can not be determined without obtaining specific gaming meter data, such as the gross meter data or delta data. As illustrated in FIG. 4, the transformed performance data graph illustrates that the gaming machine was performing on days 1-12, non-performing on days 13-15, and performing on days 16-21.

It may now be known that other operations may be performed to the relative performance data to obtain the transformed performance data. For example and not intended to be limiting, the transformed performance value may be calculated by:

T_{d}=M*R_{d}*T_{d-n} (4)

wherein: T_{d} is the current transformed performance value
R_{d} is the current relative performance value
T_{d-n} is the previous non-zero transformed performance value
M is a constant and/or variable

M may be any arbitrary constant and/or variable. Alternatively, M may be a variable that may depend upon the raw meter values, delta values, relative performance value or any other variables. Multiplying the relative performance values by an arbitrary constant and/or variable may generate a transformed performance value in which no confidential data will be revealed.

As such, the information from the transformed performance data may be used to evaluate the relative performance of the gaming machine to determine whether the gaming machine is performing or non-performing and for any of the other reasons discussed above. The transformed performance data may be calculated without revealing any confidential information.

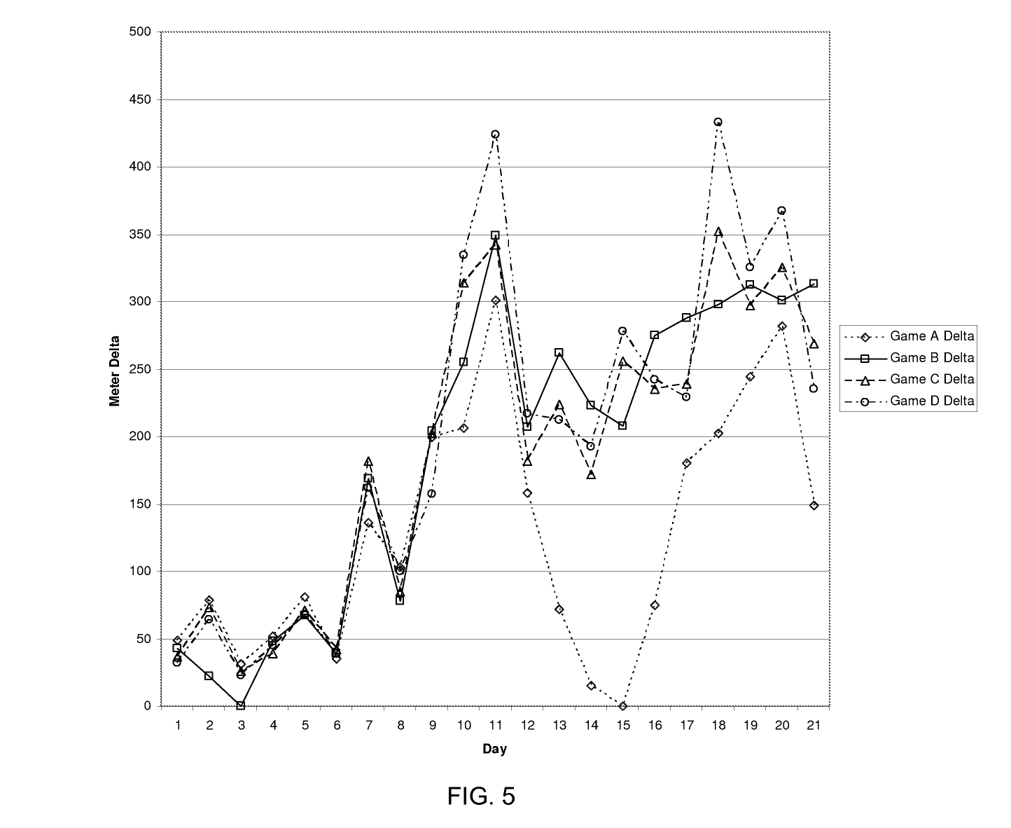

The embodiment described above is illustrated with the use of one gaming machine. However, the use of one gaming machine is not intended to be limiting as a bank of gaming machines may be used. For example, a bank of gaming machines may be used to evaluate a specific game theme. One gaming machine may be considered the baseline gaming machine to compare the data with the other gaming machines. FIGS. 5, 6, 7, and Tables 2-4 may be used to illustrate an example embodiment using a bank of gaming machines. Although illustrated with the use of four gaming machines, the number is not intended to be limiting as any number of gaming machines may be used.

Table 2 lists example delta values for gaming machines A, B, C, and D, with gaming machine A used as the baseline device. Although illustrated with gaming machine A as the baseline device, it is not intended to be limiting as any of the other gaming machines may be used as the baseline device. In Table 2, gaming data was obtained for days 1-21. For days 1-21, gross meter data for the number of coins-in for a gaming machine may be obtained. Thus, on day 1, 49 coins were inserted into gaming machine A, 43 coins in gaming machine B, 37 coins in gaming machine C, and 32 coins in gaming machine D. On day 2, 128 coins were inserted into gaming machine A, 65 coins in gaming machine B, 110 coins in gaming machine C, and 96 coins in gaming machine D.

TABLE 2

| | Game A | Game B | Game C | Game D | | | | |
|---|---|---|---|---|---|---|---|---|
| | Gross | Gross | Gross | Gross | Game A | Game B | Game C | Game D |
| Day | Meter | Meter | Meter | Meter | Delta | Delta | Delta | Delta |
| 1 | 49 | 43 | 37 | 32 | 49 | 43 | 37 | 32 |
| 2 | 128 | 65 | 110 | 96 | 79 | 22 | 73 | 64 |
| 3 | 159 | 65 | 136 | 119 | 31 | 0 | 26 | 23 |
| 4 | 211 | 113 | 175 | 164 | 52 | 48 | 39 | 45 |
| 5 | 292 | 180 | 246 | 232 | 81 | 67 | 71 | 68 |
| 6 | 327 | 219 | 288 | 271 | 35 | 39 | 42 | 39 |
| 7 | 463 | 388 | 470 | 433 | 136 | 169 | 182 | 162 |
| 8 | 566 | 466 | 555 | 533 | 103 | 78 | 85 | 100 |
| 9 | 765 | 670 | 757 | 690 | 199 | 204 | 202 | 157 |
| 10 | 971 | 925 | 1071 | 1024 | 206 | 255 | 314 | 334 |
| 11 | 1272 | 1226 | 1413 | 1448 | 301 | 349 | 342 | 424 |
| 12 | 1430 | 1384 | 1595 | 1665 | 158 | 207 | 182 | 217 |
| 13 | 1502 | 1646 | 1819 | 1877 | 72 | 262 | 224 | 212 |
| 14 | 1517 | 1869 | 1991 | 2069 | 15 | 223 | 172 | 192 |
| 15 | 1517 | 2077 | 2247 | 2347 | 0 | 208 | 256 | 278 |
| 16 | 1592 | 2352 | 2482 | 2589 | 75 | 275 | 235 | 242 |
| 17 | 1772 | 2640 | 2721 | 2818 | 180 | 288 | 239 | 229 |
| 18 | 1974 | 2938 | 3073 | 3251 | 202 | 298 | 352 | 433 |
| 19 | 2218 | 3250 | 3370 | 3576 | 244 | 312 | 297 | 325 |
| 20 | 2500 | 3551 | 3695 | 3943 | 282 | 301 | 325 | 367 |
| 21 | 2649 | 3864 | 3964 | 4178 | 149 | 313 | 269 | 235 |

FIG. 5 illustrates a graph of the delta data for a bank of gaming machines. As can be seen in FIG. 5, gaming machine A generally gains in popularity from days 1-12, slows from day 13-16, and increases again in popularity from days 17-21. Gaming machine B does not gain popularity until day 4-11 and generally remains steady from days 12-21. Gaming machine C generally gains in popularity from days 1-11, decreases for day 12, and then generally increases again from days 13-21. Gaming machine D generally increases in popularity from days 1-11, decreases in days 12-13, increases again on days 14-18, then generally decreases from days 18-21. This information would be valuable to determine whether the gaming machines were performing or non-performing and for any of the other reasons discussed above. However, the gross meter data and delta data may be considered confidential information that casinos are reluctant to share.

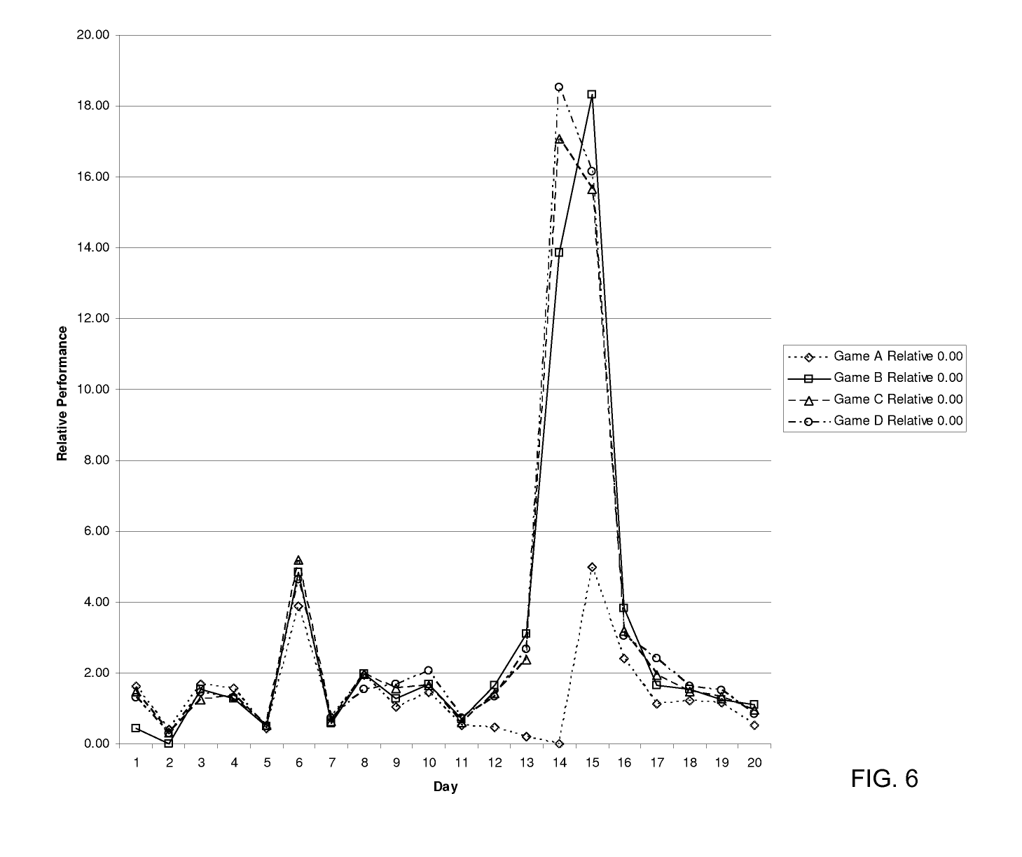

FIG. 6 illustrates a graph of the relative performance data for a bank of gaming machines. The relative performance data may be calculated by dividing the current delta value by the previous non-zero baseline device delta value:

$${R}_{d} = \frac{{Δ}_{d}}{{Δ}_{b - n}} \qquad ( 6 )$$

wherein: R_{d} is the current relative performance value
Δ_{d} is the current delta value
Δ_{b-n} is the previous day's non-zero delta value for the baseline machine

If the previous day's delta value is zero, another previous day's delta value may be used until the delta value is greater than zero. For example, as illustrated in Table 2, on day 15, the delta value is 0 for gaming machine A. Thus, the delta value from day 14 may be used to calculate the relative performance value. Therefore, the relative performance data may be provided in relation to one baseline device as illustrated in Table 3.

TABLE 3

| | Game A | Game B | Game C | Game D |
|---|---|---|---|---|
| | Relative | Relative | Relative | Relative |
| Day | Performance | Performance | Performance | Performance |
| 1 | 0.00 | 0.00 | 0.00 | 0.00 |
| 2 | 1.61 | 0.45 | 1.49 | 1.31 |
| 3 | 0.39 | 0.00 | 0.33 | 0.29 |
| 4 | 1.68 | 1.55 | 1.26 | 1.45 |
| 5 | 1.56 | 1.29 | 1.37 | 1.31 |
| 6 | 0.43 | 0.48 | 0.52 | 0.48 |
| 7 | 3.89 | 4.83 | 5.20 | 4.63 |
| 8 | 0.76 | 0.57 | 0.63 | 0.74 |
| 9 | 1.93 | 1.98 | 1.96 | 1.52 |
| 10 | 1.04 | 1.28 | 1.58 | 1.68 |
| 11 | 1.46 | 1.69 | 1.66 | 2.06 |
| 12 | 0.52 | 0.69 | 0.60 | 0.72 |
| 13 | 0.46 | 1.66 | 1.42 | 1.34 |
| 14 | 0.21 | 3.10 | 2.39 | 2.67 |
| 15 | 0.00 | 13.87 | 17.07 | 18.53 |
| 16 | 5.00 | 18.33 | 15.67 | 16.13 |
| 17 | 2.40 | 3.84 | 3.19 | 3.05 |
| 18 | 1.12 | 1.66 | 1.96 | 2.41 |
| 19 | 1.21 | 1.54 | 1.47 | 1.61 |
| 20 | 1.16 | 1.23 | 1.33 | 1.50 |
| 21 | 0.53 | 1.11 | 0.95 | 0.83 |

As can be seen in FIG. 6, the relative performance data graph does not look like the delta value graph of FIG. 5. Furthermore, no confidential or financial data about the gaming machine is revealed from the relative performance data. As such, the relative performance data may be provided to third parties outside the casino without revealing the confidential information, such as financial data.

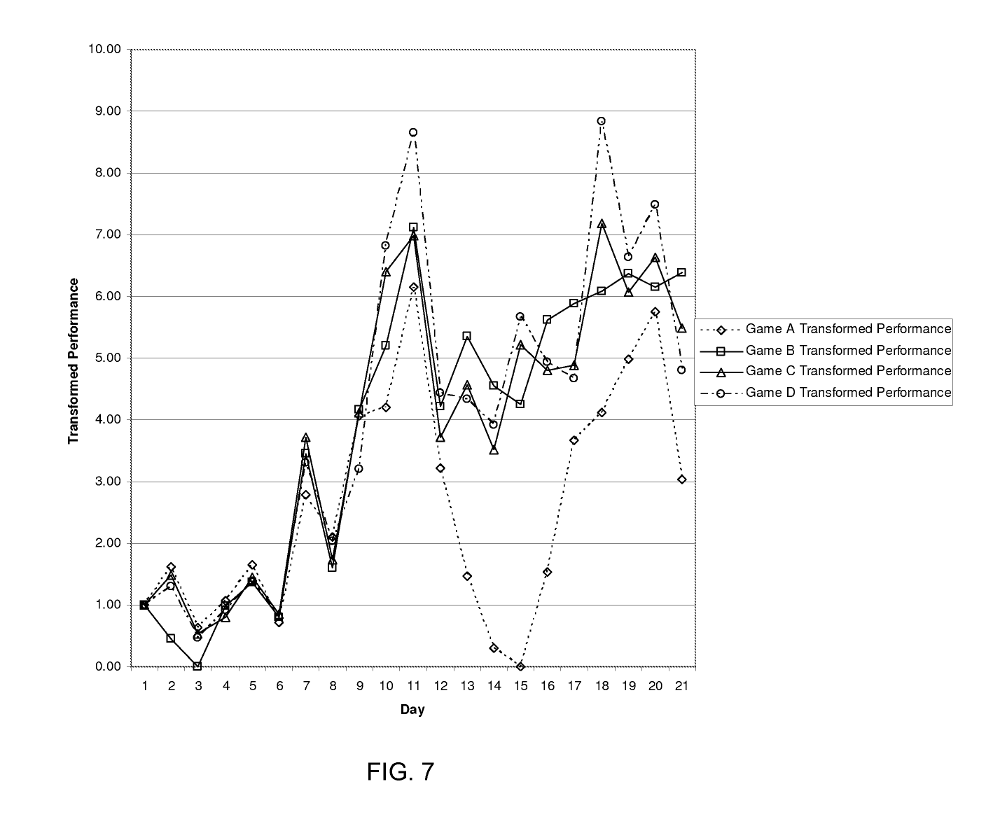

FIG. 7 illustrates a graph of the transformed performance data for the bank of gaming machines. The data may then be transformed by multiplying the current relative performance value by the previous transformed value of the baseline machine:

T_{d}=R_{d}*T_{b-n} (7)

wherein: T_{d} is the current transformed performance value
R_{d} is the current relative performance value
T_{b-n} is the previous non-zero transformed performance value of the baseline machine

Table 4 is a table of the transformed performance values for gaming machines A, B, C, and D. If the previous day's transformed performance value is zero, another previous day's transformed performance value may be used until the transformed performance value is greater than zero.

TABLE 4

| | Game A | Game B | Game C | Game D |
|---|---|---|---|---|
| | Transformed | Transformed | Transformed | Transformed |
| Day | Performance | Performance | Performance | Performance |
| 1 | 1.00 | 1.00 | 1.00 | 1.00 |
| 2 | 1.61 | 0.45 | 1.49 | 1.31 |
| 3 | 0.63 | 0.00 | 0.53 | 0.47 |
| 4 | 1.06 | 0.98 | 0.80 | 0.92 |
| 5 | 1.65 | 1.37 | 1.45 | 1.39 |
| 6 | 0.71 | 0.80 | 0.86 | 0.80 |
| 7 | 2.78 | 3.45 | 3.71 | 3.31 |
| 8 | 2.10 | 1.59 | 1.73 | 2.04 |
| 9 | 4.06 | 4.16 | 4.12 | 3.20 |
| 10 | 4.20 | 5.20 | 6.41 | 6.82 |
| 11 | 6.14 | 7.12 | 6.98 | 8.65 |
| 12 | 3.22 | 4.22 | 3.71 | 4.43 |
| 13 | 1.47 | 5.35 | 4.57 | 4.33 |
| 14 | 0.31 | 4.55 | 3.51 | 3.92 |
| 15 | 0.00 | 4.24 | 5.22 | 5.67 |
| 16 | 1.53 | 5.61 | 4.80 | 4.94 |
| 17 | 3.67 | 5.88 | 4.88 | 4.67 |
| 18 | 4.12 | 6.08 | 7.18 | 8.84 |
| 19 | 4.98 | 6.37 | 6.06 | 6.63 |
| 20 | 5.76 | 6.14 | 6.63 | 7.49 |
| 21 | 3.04 | 6.39 | 5.49 | 4.80 |

The transformed performance data graph of FIG. 7 may be similar to the delta data graph of FIG. 5 as it may accurately represent the slopes for each graph segment from the delta data graph of FIG. 5. However, the scale of each graph is different and confidential information can not be determined without obtaining specific gaming meter data, such as the gross meter data or delta data. Similar to FIG. 5, the transformed performance data graph of FIG. 7 illustrates that gaming machine A was performing on days 1-12, non-performing on days 13-15, and performing on days 16-21; gaming machine B was non-performing on days 1-3, performing on days 4-11, and steady from days 12-21; gaming machine C was performing on days 1-11, non-performing on days 12-13, and performing on days 13-21; and gaming machine D was performing on days 1-11, non-performing on days 12-13, performing on days 14-18, and non-performing on days 18-21.

This allows for an accurate graph of all devices as compared to the other devices without revealing specific gaming meter data. As discussed above, it will now be known that other operations may be performed to the raw meter data to remove the confidential information or data to obtain the relative performance data and/or to the relative performance data to obtain the transformed performance data.

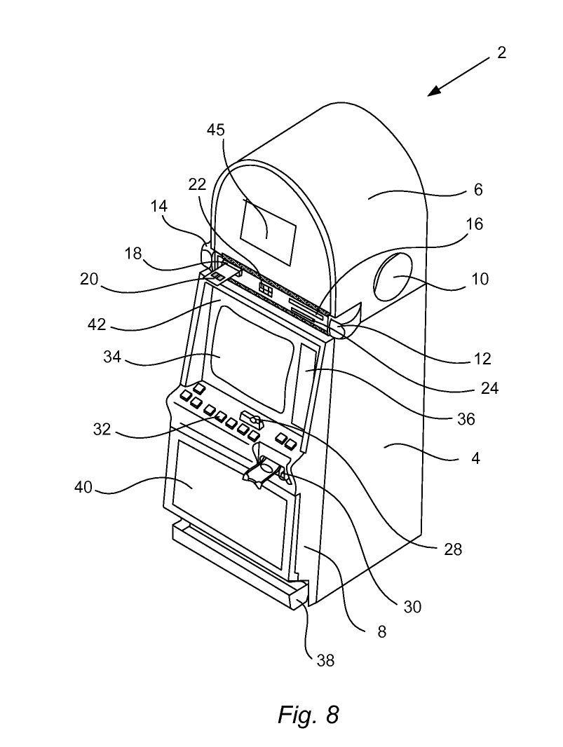

FIG. 8 illustrates an example embodiment of a gaming machine. Machine 2 includes a main cabinet 4, which generally surrounds the machine interior (not shown) and is viewable by users. The main cabinet includes a main door 8 on the front of the machine, which opens to provide access to the interior of the machine. Attached to the main door are player-input switches or buttons 32, a coin acceptor 28, and a bill validator 30, a coin tray 38, and a belly glass 40. Viewable through the main door is a video display monitor 34 and an information panel 36. The display monitor 34 will typically be a cathode ray tube, high resolution flat-panel LCD, or other conventional electronically controlled video monitor. The information panel 36 may be a back-lit, silk screened glass panel with lettering to indicate general game information including, for example, a game denomination (e.g. $0.25 or $1). The bill validator 30, player-input switches 32, video display monitor 34, and information panel are devices used to play a game on the game machine 2. The devices are controlled by circuitry (e.g. the master gaming controller) housed inside the main cabinet 4 of the machine 2.

Many different types of games, including mechanical slot games, video slot games, video poker, video black jack, video pachinko and lottery, may be provided with gaming machines of this invention. In particular, the gaming machine 2 may be operable to provide a play of many different instances of games of chance. The instances may be differentiated according to themes, sounds, graphics, type of game (e.g., slot game vs. card game), denomination, number of paylines, maximum jackpot, progressive or non-progressive, bonus games, etc. The gaming machine 2 may be operable to allow a player to select a game of chance to play from a plurality of instances available on the gaming machine. For example, the gaming machine may provide a menu with a list of the instances of games that are available for play on the gaming machine and a player may be able to select from the list a first instance of a game of chance that they wish to play.

The various instances of games available for play on the gaming machine 2 may be stored as game software on a mass storage device in the gaming machine or may be generated on a remote gaming device but then displayed on the gaming machine. The gaming machine 2 may executed game software, such as but not limited to video streaming software that allows the game to be displayed on the gaming machine. When an instance is stored on the gaming machine 2, it may be loaded from the mass storage device into a RAM for execution. In some cases, after a selection of an instance, the game software that allows the selected instance to be generated may be downloaded from a remote gaming device, such as another gaming machine.

The gaming machine 2 includes a top box 6, which sits on top of the main cabinet 4. The top box 6 houses a number of devices, which may be used to add features to a game being played on the gaming machine 2, including speakers 10, 12, 14, a ticket printer 18 which prints bar-coded tickets 20, a key pad 22 for entering player tracking information, a florescent display 16 for displaying player tracking information, a card reader 24 for entering a magnetic striped card containing player tracking information, and a video display screen 42. The ticket printer 18 may be used to print tickets for a cashless ticketing system. Further, the top box 6 may house different or additional devices than shown in FIG. 8. For example, the top box may contain a bonus wheel or a back-lit silk screened panel which may be used to add bonus features to the game being played on the gaming machine. As another example, the top box may contain a display for a progressive jackpot offered on the gaming machine. During a game, these devices are controlled and powered, in part, by circuitry (e.g. a master gaming controller) housed within the main cabinet 4 of the machine 2.

Understand that gaming machine 2 is but one example from a wide range of gaming machine designs on which the present invention may be implemented. For example, not all suitable gaming machines have top boxes or player tracking features. Further, some gaming machines have only a single game display—mechanical or video, while others are designed for bar tables and have displays that face upwards. As another example, a game may be generated in on a host computer and may be displayed on a remote terminal or a remote gaming device. The remote gaming device may be connected to the host computer via a network of some type such as a local area network, a wide area network, an intranet or the Internet. The remote gaming device may be a portable gaming device such as but not limited to a cell phone, a personal digital assistant, and a wireless game player. Images rendered from 3-D gaming environments may be displayed on portable gaming devices that are used to play a game of chance. Further a gaming machine or server may include gaming logic for commanding a remote gaming device to render an image from a virtual camera in a 3-D gaming environments stored on the remote gaming device and to display the rendered image on a display located on the remote gaming device. Thus, those of skill in the art will understand that the present invention, as described below, can be deployed on most any gaming machine now available or hereafter developed.

Some gaming machines may be implemented with special features and/or additional circuitry that differentiates them from general-purpose computers (e.g., desktop PC's and laptops). Gaming machines are highly regulated to ensure fairness and, in many cases, gaming machines are operable to dispense monetary awards of multiple millions of dollars. Therefore, to satisfy security and regulatory requirements in a gaming environment, hardware and software architectures may be implemented in gaming machines that differ significantly from those of general-purpose computers. A description of gaming machines relative to general-purpose computing machines and some examples of the additional (or different) components and features found in gaming machines are described below.

At first glance, one might think that adapting PC technologies to the gaming industry would be a simple proposition because both PCs and gaming machines employ microprocessors that control a variety of devices. However, because of such reasons as 1) the regulatory requirements that are placed upon gaming machines, 2) the harsh environment in which gaming machines operate, 3) security requirements and 4) fault tolerance requirements, adapting PC technologies to a gaming machine can be quite difficult. Further, techniques and methods for solving a problem in the PC industry, such as device compatibility and connectivity issues, might not be adequate in the gaming environment. For instance, a fault or a weakness tolerated in a PC, such as security holes in software or frequent crashes, may not be tolerated in a gaming machine because in a gaming machine these faults can lead to a direct loss of funds from the gaming machine, such as stolen cash or loss of revenue when the gaming machine is not operating properly.

For the purposes of illustration, a few differences between PC systems and gaming systems will be described. A first difference between gaming machines and common PC based computers systems is that gaming machines are designed to be state-based systems. In a state-based system, the system stores and maintains its current state in a non-volatile memory, such that, in the event of a power failure or other malfunction the gaming machine will return to its current state when the power is restored. For instance, if a player was shown an award for a game of chance and, before the award could be provided to the player the power failed, the gaming machine, upon the restoration of power, would return to the state where the award is indicated. As anyone who has used a PC, knows, PCs are not state machines and a majority of data is usually lost when a malfunction occurs. This requirement affects the software and hardware design on a gaming machine.

A second important difference between gaming machines and common PC based computer systems is that for regulation purposes, the software on the gaming machine used to generate the game of chance and operate the gaming machine has been designed to be static and monolithic to prevent cheating by the operator of gaming machine. For instance, one solution that has been employed in the gaming industry to prevent cheating and satisfy regulatory requirements has been to manufacture a gaming machine that can use a proprietary processor running instructions to generate the game of chance from an erasable programmable read-only memory (EPROM) or other form of non-volatile memory. The coding instructions on the EPROM are static (non-changeable) and must be approved by a gaming regulators in a particular jurisdiction and installed in the presence of a person representing the gaming jurisdiction. Any changes to any part of the software required to generate the game of chance, such as adding a new device driver used by the master gaming controller to operate a device during generation of the game of chance can require a new EPROM to be burnt, approved by the gaming jurisdiction and reinstalled on the gaming machine in the presence of a gaming regulator. Regardless of whether the EPROM solution is used, to gain approval in most gaming jurisdictions, a gaming machine must demonstrate sufficient safeguards that prevent an operator or player of a gaming machine from manipulating hardware and software in a manner that gives them an unfair and some cases an illegal advantage. The gaming machine should have a means to determine if the code it will execute is valid. If the code is not valid, the gaming machine must have a means to prevent the code from being executed. The code validation requirements in the gaming industry affect both hardware and software designs on gaming machines.

A third important difference between gaming machines and common PC based computer systems is the number and kinds of peripheral devices used on a gaming machine are not as great as on PC based computer systems. Traditionally, in the gaming industry, gaming machines have been relatively simple in the sense that the number of peripheral devices and the number of functions the gaming machine has been limited. Further, in operation, the functionality of gaming machines were relatively constant once the gaming machine was deployed, i.e., new peripherals devices and new gaming software were infrequently added to the gaming machine. This differs from a PC where users will go out and buy different combinations of devices and software from different manufacturers and connect them to a PC to suit their needs depending on a desired application. Therefore, the types of devices connected to a PC may vary greatly from user to user depending in their individual requirements and may vary significantly over time.

Although the variety of devices available for a PC may be greater than on a gaming machine, gaming machines still have unique device requirements that differ from a PC, such as device security requirements not usually addressed by PCs. For instance, monetary devices, such as coin dispensers, bill validators and ticket printers and computing devices that are used to govern the input and output of cash to a gaming machine have security requirements that are not typically addressed in PCs. Therefore, many PC techniques and methods developed to facilitate device connectivity and device compatibility do not address the emphasis placed on security in the gaming industry.

To address some of the issues described above, a number of hardware/software components and architectures are utilized in gaming machines that are not typically found in general purpose computing devices, such as PCs. These hardware/software components and architectures, as described below in more detail, include but are not limited to watchdog timers, voltage monitoring systems, state-based software architecture and supporting hardware, specialized communication interfaces, security monitoring and trusted memory.

A watchdog timer is normally used in gaming machines to provide a software failure detection mechanism. In a normally operating system, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits contain a loadable timeout counter register to allow the operating software to set the timeout interval within a certain range of time. A differentiating feature of the some preferred circuits is that the operating software cannot completely disable the function of the watchdog timer. In other words, the watchdog timer always functions from the time power is applied to the board.

Gaming computer platforms preferably use several power supply voltages to operate portions of the computer circuitry. These can be generated in a central power supply or locally on the computer board. If any of these voltages falls out of the tolerance limits of the circuitry they power, unpredictable operation of the computer may result. Though most modern general-purpose computers include voltage monitoring circuitry, these types of circuits only report voltage status to the operating software. Out of tolerance voltages can cause software malfunction, creating a potential uncontrolled condition in the gaming computer. Gaming machines of the present assignee typically have power supplies with tighter voltage margins than that required by the operating circuitry. In addition, the voltage monitoring circuitry implemented in gaming computers typically has two thresholds of control. The first threshold generates a software event that can be detected by the operating software and an error condition generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the computer.

The standard method of operation for slot machine game software is to use a state machine. Different functions of the game (bet, play, result, points in the graphical presentation, etc.) may be defined as a state. When a game moves from one state to another, critical data regarding the game software is stored in a custom non-volatile memory subsystem. This is critical to ensure the player's wager and credits are preserved and to minimize potential disputes in the event of a malfunction on the gaming machine.

In general, the gaming machine does not advance from a first state to a second state until critical information that allows the first state to be reconstructed is stored. This feature allows the game to recover operation to the current state of play in the event of a malfunction, loss of power, etc that occurred just prior to the malfunction. After the state of the gaming machine is restored during the play of a game of chance, game play may resume and the game may be completed in a manner that is no different than if the malfunction had not occurred. Typically, battery backed RAM devices are used to preserve this critical data although other types of non-volatile memory devices may be employed. These memory devices are not used in typical general-purpose computers.

As described in the preceding paragraph, when a malfunction occurs during a game of chance, the gaming machine may be restored to a state in the game of chance just prior to when the malfunction occurred. The restored state may include metering information and graphical information that was displayed on the gaming machine in the state prior to the malfunction. For example, when the malfunction occurs during the play of a card game after the cards have been dealt, the gaming machine may be restored with the cards that were previously displayed as part of the card game. As another example, a bonus game may be triggered during the play of a game of chance where a player is required to make a number of selections on a video display screen. When a malfunction has occurred after the player has made one or more selections, the gaming machine may be restored to a state that shows the graphical presentation at the just prior to the malfunction including an indication of selections that have already been made by the player. In general, the gaming machine may be restored to any state in a plurality of states that occur in the game of chance that occurs while the game of chance is played or to states that occur between the play of a game of chance.

Game history information regarding previous games played such as an amount wagered, the outcome of the game and so forth may also be stored in a non-volatile memory device. The information stored in the non-volatile memory may be detailed enough to reconstruct a portion of the graphical presentation that was previously presented on the gaming machine and the state of the gaming machine (e.g., credits) at the time the game of chance was played. The game history information may be utilized in the event of a dispute. For example, a player may decide that in a previous game of chance that they did not receive credit for an award that they believed they won. The game history information may be used to reconstruct the state of the gaming machine prior, during and/or after the disputed game to demonstrate whether the player was correct or not in their assertion.

Another feature of gaming machines is that they often contain unique interfaces, including serial interfaces, to connect to specific subsystems internal and external to the slot machine. The serial devices may have electrical interface requirements that differ from the “standard” EIA 232 serial interfaces provided by general-purpose computers. These interfaces may include EIA 485, EIA 422, Fiber Optic Serial, optically coupled serial interfaces, current loop style serial interfaces, etc. In addition, to conserve serial interfaces internally in the slot machine, serial devices may be connected in a shared, daisy-chain fashion where multiple peripheral devices are connected to a single serial channel.

The serial interfaces may be used to transmit information using communication protocols that are unique to the gaming industry. For example, IGT's Netplex is a proprietary communication protocol used for serial communication between gaming devices. As another example, Serial-attached SCSI (SAS) is a communication protocol used to transmit information, such as metering information, from a gaming machine to a remote device. Often SAS is used in conjunction with a player tracking system.

Gaming machines may alternatively be treated as peripheral devices to a casino communication controller and connected in a shared daisy chain fashion to a single serial interface. In both cases, the peripheral devices are preferably assigned device addresses. If so, the serial controller circuitry must implement a method to generate or detect unique device addresses. General-purpose computer serial ports are not able to do this.

Security monitoring circuits detect intrusion into a gaming machine by monitoring security switches attached to access doors in the slot machine cabinet. Preferably, access violations result in suspension of game play and can trigger additional security operations to preserve the current state of game play. These circuits also function when power is off by use of a battery backup. In power-off operation, these circuits continue to monitor the access doors of the slot machine. When power is restored, the gaming machine can determine whether any security violations occurred while power was off, e.g., via software for reading status registers. This can trigger event log entries and further data authentication operations by the slot machine software.

Trusted memory devices are preferably included in a gaming machine computer to ensure the authenticity of the software that may be stored on less secure memory subsystems, such as mass storage devices. Trusted memory devices and controlling circuitry are typically designed to not allow modification of the code and data stored in the memory device while the memory device is installed in the slot machine. The code and data stored in these devices may include authentication algorithms, random number generators, authentication keys, operating system kernels, etc. The purpose of these trusted memory devices is to provide gaming regulatory authorities a root trusted authority within the computing environment of the slot machine that can be tracked and verified as original. This may be accomplished via removal of the trusted memory device from the slot machine computer and verification of the secure memory device contents is a separate third party verification device. Once the trusted memory device is verified as authentic, and based on the approval of the verification algorithms contained in the trusted device, the gaming machine is allowed to verify the authenticity of additional code and data that may be located in the gaming computer assembly, such as code and data stored on hard disk drives. A few details related to trusted memory devices that may be used in the present invention are described in U.S. Pat. No. 6,685,567 from U.S. patent application Ser. No. 09/925,098, filed Aug. 8, 2001 and titled “Process Verification,” which is incorporated herein in its entirety and for all purposes.

Mass storage devices used in a general purpose computer typically allow code and data to be read from and written to the mass storage device. In a gaming machine environment, modification of the gaming code stored on a mass storage device is strictly controlled and would only be allowed under specific maintenance type events with electronic and physical enablers required. Though this level of security could be provided by software, gaming computers that include mass storage devices preferably include hardware level mass storage data protection circuitry that operates at the circuit level to monitor attempts to modify data on the mass storage device and will generate both software and hardware error triggers should a data modification be attempted without the proper electronic and physical enablers being present.

Returning to the example of FIG. 8, when a user wishes to play the gaming machine 2, he or she inserts cash through the coin acceptor 28 or bill validator 30. Additionally, the bill validator may accept a printed ticket voucher which may be accepted by the bill validator 30 as indicia of credit when a cashless ticketing system is used. At the start of the game, the player may enter playing tracking information using the card reader 24, the keypad 22, and the florescent display 16. Further, other game preferences of the player playing the game may be read from a card inserted into the card reader. During the game, the player views game information using the video display 34. Other game and prize information may also be displayed in the video display screen 42 located in the top box.

During the course of a game, a player may be required to make a number of decisions, which affect the outcome of the game. For example, a player may vary his or her wager on a particular game, select a prize for a particular game selected from a prize server, or make game decisions that affect the outcome of a particular game. The player may make these choices using the player-input switches 32, the video display screen 34 or using some other device which enables a player to input information into the gaming machine. In some embodiments, the player may be able to access various game services such as concierge services and entertainment content services using the video display screen 34 and one more input devices.

During certain game events, the gaming machine 2 may display visual and auditory effects that can be perceived by the player. These effects add to the excitement of a game, which makes a player more likely to continue playing. Auditory effects include various sounds that are projected by the speakers 10, 12, 14. Visual effects include flashing lights, strobing lights or other patterns displayed from lights on the gaming machine 2 or from lights behind the belly glass 40. After the player has completed a game, the player may receive game tokens from the coin tray 38 or the ticket 20 from the printer 18, which may be used for further games or to redeem a prize. Further, the player may receive a ticket 20 for food, merchandise, or games from the printer 18.

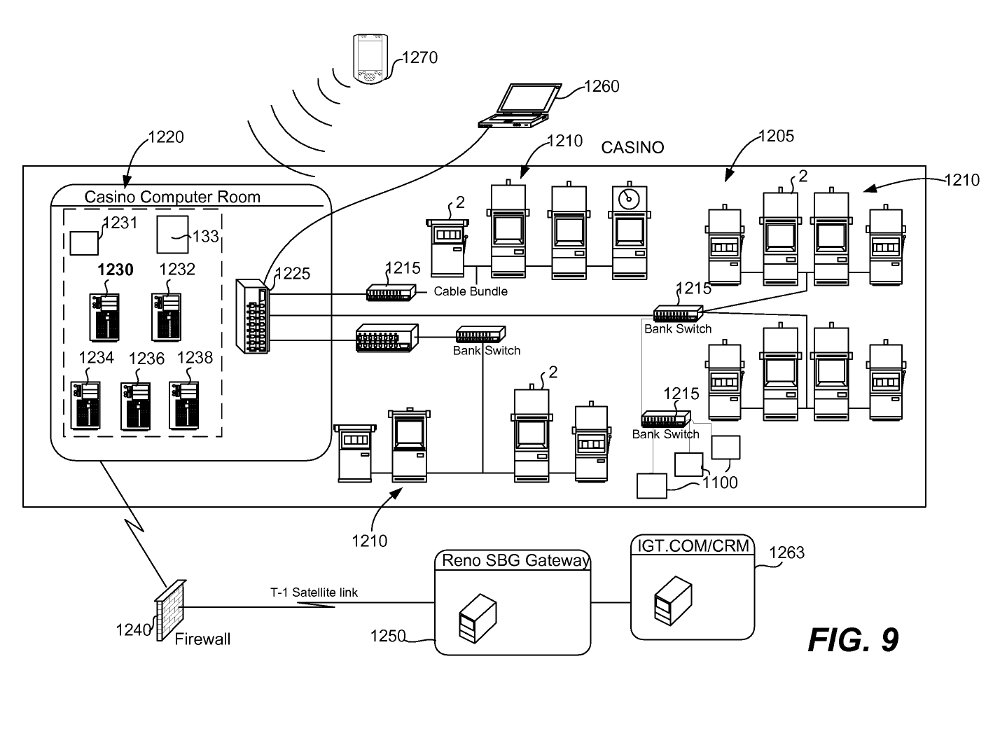

FIG. 9 illustrates an example embodiment of a network topology. Those of skill in the art will realize that this exemplary architecture and the related functionality are merely examples and that the present invention encompasses many other such embodiments and methods. Here, for example, a single gaming establishment 1205 is illustrated, which is a casino in this example. However, it should be understood that some implementations of the present invention involve multiple gaming establishments.

Gaming establishment 1205 includes 16 gaming machines 2, each of which is part of a bank 1210 of gaming machines 2. In this example, gaming establishment 1205 also includes a bank of networked gaming tables 1100. It will be appreciated that many gaming establishments include hundreds or even thousands of gaming machines 2 and/or gaming tables 1100, not all of which are included in a bank. However, the present invention may be implemented in gaming establishments having any number of gaming machines, gaming tables, and the like.

Various alternative network topologies can be used to implement different aspects of the invention and/or to accommodate varying numbers of networked devices. For example, gaming establishments with very large numbers of gaming machines 2 may require multiple instances of some network devices (e.g., of main network device 1225, which combines switching and routing functionality in this example) and/or the inclusion of other network devices not shown in FIG. 9. For example, some implementations of the invention include one or more middleware servers disposed between gaming machines 2 and server 1230. Such middleware servers can provide various useful functions, including but not limited to the filtering and/or aggregation of data received from bank switches 1215, from individual gaming machines and from other player terminals. Some implementations of the invention include load balancing methods and devices for managing network traffic.

Each bank 1210 has a corresponding bank switch 1215, which may be a conventional bank switch. Each bank switch is connected to server-based gaming (“SBG”) server 1230 via main network device 1225, which combines switching and routing functionality in this example. Although various floor communication protocols may be used, some preferred implementations use IGT's open, Ethernet-based SuperSAS® protocol, which IGT makes available for downloading without charge. However, other protocols such as Best of Breed (“BOB”) may be used to implement various aspects of SBG. IGT has also developed a gaming-industry-specific transport layer called CASH that rides on top of TCP/IP and offers additional functionality and security.

SBG server 1230, License Manager 1231, Arbiter 133, servers 1232, 1234, 1236 and 1238, and main network device 1225 are disposed within computer room 1220 of gaming establishment 1205. In practice, more or fewer servers may be used. Some of these servers may be configured to perform tasks relating to player tracking, bonusing/progressives, etc. Some servers may be configured to perform tasks specific to the present invention. License Manager 1231 may also be implemented, at least in part, via a server or a similar device. Some exemplary operations of License Manager 1231 are described in detail in U.S. patent application Ser. No. 11/225,408, entitled “METHODS AND DEVICES FOR AUTHENTICATION AND LICENSING IN A GAMING NETWORK” by Kinsley et al., which is hereby incorporated by reference.

SBG server 1230 can also be configured to implement, at least in part, various aspects of the present invention. Some preferred embodiments of SBG server 1230 and the other servers shown in FIG. 9 include (or are at least in communication with) clustered CPUs, redundant storage devices, including backup storage devices, switches, etc. Such storage devices may include a redundant array of inexpensive disks (“RAID”), back-up hard drives and/or tape drives, etc. Preferably, a Radius and a DHCP server are also configured for communication with the gaming network. Some implementations of the invention provide one or more of these servers in the form of blade servers.

In some implementations of the invention, many of these devices (including but not limited to License Manager 1231, servers 1232, 1234, 1236 and 1238, and main network device 1225) are mounted in a single rack with SBG server 1230. Accordingly, many or all such devices will sometimes be referenced in the aggregate as an “SBG server.” However, in alternative implementations, one or more of these devices is in communication with SBG server 1230 and/or other devices of the network but located elsewhere. For example, some of the devices could be mounted in separate racks within computer room 1220 or located elsewhere on the network. For example, it can be advantageous to store large volumes of data elsewhere via a storage area network (“SAN”). In some embodiments, these components are SBG server 1230 preferably has an uninterruptible power supply (“UPS”). The UPS may be, for example, a rack-mounted UPS module.

Computer room 1220 may include one or more operator consoles or other host devices that are configured for communication with SBG server 1230. Such host devices may be provided with software, hardware and/or firmware for implementing various aspects of the invention; many of these aspects involve controlling SBG server 1230. However, such host devices need not be located within computer room 1220. Wired host device 1260 (which is a laptop computer in this example) and wireless host device (which is a PDA in this example) may be located elsewhere in gaming establishment 1205 or at a remote location.

Arbiter 133 may be implemented, for example, via software that is running on a server or another networked device. Arbiter 133 serves as an intermediary between different devices on the network. Some implementations of Arbiter 133 are described in U.S. patent application Ser. No. 10/948,387, entitled “METHODS AND APPARATUS FOR NEGOTIATING COMMUNICATIONS WITHIN A GAMING NETWORK” and filed Sep. 23, 2004 (the “Arbiter Application”), which is incorporated herein by reference and for all purposes. In some preferred implementations, Arbiter 133 is a repository for the configuration information required for communication between devices on the gaming network (and, in some implementations, devices outside the gaming network). Although Arbiter 133 can be implemented in various ways, one exemplary implementation is discussed in the following paragraphs.

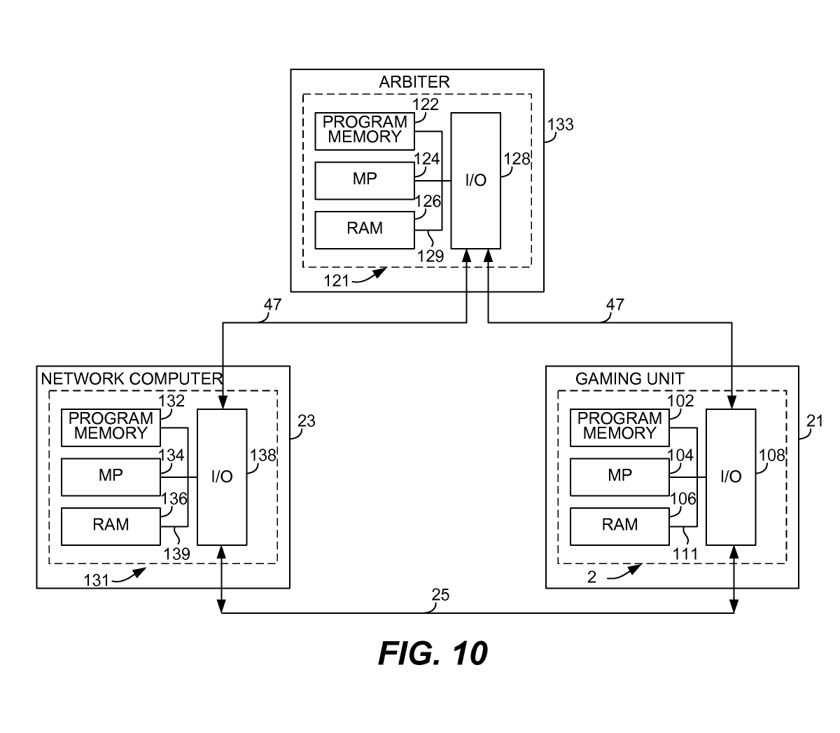

FIG. 10 is a block diagram of a simplified communication topology between a gaming unit 21, the network computer 23 and the Arbiter 133. Although only one gaming unit 21, one network computer 23 and one Arbiter 133 are shown in FIG. 10, it should be understood that the following examples may be applicable to different types of network gaming devices within the gaming network 12 beyond the gaming unit 21 and the network computer 23, and may include different numbers of network computers, gaming security arbiters and gaming units. For example, a single Arbiter 133 may be used for secure communications among a plurality of network computers 23 and tens, hundreds or thousands of gaming units 21. Likewise, multiple gaming security arbiters 46 may be utilized for improved performance and other scalability factors.

Referring to FIG. 10, the Arbiter 133 may include an arbiter controller 121 that may comprise a program memory 122, a microcontroller or microprocessor (MP) 124, a random-access memory (RAM) 126 and an input/output (I/O) circuit 128, all of which may be interconnected via an address/data bus 129. The network computer 23 may also include a controller 131 that may comprise a program memory 132, a microcontroller or microprocessor (MP) 134, a random-access memory (RAM) 136 and an input/output (I/O) circuit 138, all of which may be interconnected via an address/data bus 139. It should be appreciated that although the Arbiter 133 and the network computer 23 are each shown with only one microprocessor 124, 134, the controllers 121, 131 may each include multiple microprocessors 124, 134. Similarly, the memory of the controllers 121, 131 may include multiple RAMs 126, 136 and multiple program memories 122, 132. Although the I/O circuits 128, 138 are each shown as a single block, it should be appreciated that the I/O circuits 128, 138 may include a number of different types of I/O circuits. The RAMs 124, 134 and program memories 122, 132 may be implemented as semiconductor memories, magnetically readable memories, and/or optically readable memories, for example.

Although the program memories 122, 132 are shown in FIG. 10 as read-only memories (ROM) 122, 132, the program memories of the controllers 121, 131 may be a read/write or alterable memory, such as a hard disk. In the event a hard disk is used as a program memory, the address/data buses 129, 139 shown schematically in FIG. 10 may each comprise multiple address/data buses, which may be of different types, and there may be an I/O circuit disposed between the address/data buses.

As shown in FIG. 10, the gaming unit 21 may be operatively coupled to the network computer 23 via the data link 25. The gaming unit 21 may also be operatively coupled to the Arbiter 133 via the data link 47, and the network computer 23 may likewise be operatively coupled to the Arbiter 133 via the data link 47. Communications between the gaming unit 21 and the network computer 23 may involve different information types of varying levels of sensitivity resulting in varying levels of encryption techniques depending on the sensitivity of the information. For example, communications such as drink orders and statistical information may be considered less sensitive. A drink order or statistical information may remain encrypted, although with moderately secure encryption techniques, such as RC4, resulting in less processing power and less time for encryption. On the other hand, financial information (e.g., account information, winnings, etc.), game download information (e.g., game software and game licensing information) and personal information (e.g., social security number, personal preferences, etc.) may be encrypted with stronger encryption techniques such as DES or 3DES to provide increased security.

As disclosed in further detail in the Arbiter Application, the Arbiter 133 may verify the authenticity of each network gaming device. The Arbiter 133 may receive a request for a communication session from a network device. For ease of explanation, the requesting network device may be referred to as the client, and the requested network device may be referred to as the host. The client may be any device on the network 12 and the request may be for a communication session with any other network device. The client may specify the host, or the gaming security arbiter may select the host based on the request and based on information about the client and potential hosts. The Arbiter 133 may provide encryption keys (session keys) for the communication session to the client via the secure communication channel. Either the host and/or the session key may be provided in response to the request, or may have been previously provided. The client may contact the host to initiate the communication session. The host may then contact the Arbiter 133 to determine the authenticity of the client. The Arbiter 133 may provide affirmation (or lack thereof) of the authenticity of the client to the host and provide a corresponding session key, in response to which the network devices may initiate the communication session directly with each other using the session keys to encrypt and decrypt messages.

Alternatively, upon receiving a request for a communication session, the Arbiter 133 may contact the host regarding the request and provide corresponding session keys to both the client and the host. The Arbiter 133 may then initiate either the client or the host to begin their communication session. In turn, the client and host may begin the communication session directly with each other using the session keys to encrypt and decrypt messages. An additional explanation of the communication request, communication response and key distribution is provided in the Arbiter Application.

Wireless devices are particularly useful for managing a gaming network. Such wireless devices could include, but are not limited to, laptops, personal digital assistants (PDAs) or even cellular telephones. Referring once again to FIG. 9, one or more network devices in gaming establishment 1205 can be configured as wireless access points. For example, a casino manager may use a wireless handheld device to revise and/or schedule gaming machine configurations while roaming the casino floor. Similarly, a representative of a regulatory body could use a PDA to verify gaming machine configurations, generate reports, view activity logs, etc., while on the casino floor.

If a host device is located in a remote location, security methods and devices (such as firewalls, authentication and/or encryption) should be deployed in order to prevent the unauthorized access of the gaming network. Similarly, any other connection between gaming network 1205 and the outside world should only be made with trusted devices via a secure link, e.g., via a virtual private network (“VPN”) tunnel. For example, the illustrated connection between SBG 1230, gateway 1250 and central system 1263 (here, IGT.com) that may be used for game downloads, etc., is advantageously made via a VPN tunnel.

An Internet-based VPN uses the open, distributed infrastructure of the Internet to transmit data between sites. A VPN may emulate a private IP network over public or shared infrastructures. A VPN that supports only IP traffic is called an IP-VPN. VPNs provide advantages to both the service provider and its customers. For its customers, a VPN can extend the IP capabilities of a corporate site to remote offices and/or users with intranet, extranet, and dial-up services. This connectivity may be achieved at a lower cost to the gaming entity with savings in capital equipment, operations, and services. Details of VPN methods that may be used with the present invention are described in the reference, “Virtual Private Networks—Technologies and Solutions,” by R. Yueh and T. Strayer, Addison-Wesley, 2001, ISBN#0-201-70209-6, which is incorporated herein by reference and for all purposes.

There are many ways in which IP VPN services may be implemented, such as, for example, Virtual Leased Lines, Virtual Private Routed Networks, Virtual Private Dial Networks, Virtual Private LAN Segments, etc. Additionally VPNs may be implemented using a variety of protocols, such as, for example, IP Security (IPSec) Protocol, Layer 2 Tunneling Protocol, Multiprotocol Label Switching (MPLS) Protocol, etc. Details of these protocols, including Request For Comment (RFC) reports, may be obtained from the VPN Consortium, an industry trade group (http://www.vpnc.com, VPNC, Santa Cruz, Calif.).

For security purposes, any information transmitted to or from a gaming establishment over a public network may be encrypted. In one implementation, the information may be symmetrically encrypted using a symmetric encryption key, where the symmetric encryption key is asymmetrically encrypted using a private key. The public key may be obtained from a remote public key server. The encryption algorithm may reside in processor logic stored on the gaming machine. When a remote server receives a message containing the encrypted data, the symmetric encryption key is decrypted with a private key residing on the remote server and the symmetrically encrypted information sent from the gaming machine is decrypted using the symmetric encryption key. A different symmetric encryption key is used for each transaction where the key is randomly generated. Symmetric encryption and decryption is preferably applied to most information because symmetric encryption algorithms tend to be 100-10,000 faster than asymmetric encryption algorithms.

As mentioned elsewhere herein, U.S. patent application Ser. No. 11/225,408, entitled “METHODS AND DEVICES FOR AUTHENTICATION AND LICENSING IN A GAMING NETWORK” by Kinsley et al., describes novel methods and devices for authentication, game downloading and game license management. This application has been incorporated herein by reference.

Providing a secure connection between the local devices of the SBG system and IGT's central system allows for the deployment of many advantageous features. For example, a customer (e.g., an employee of a gaming establishment) can log onto an account of central system 1263 (in this example, IGT.com) to obtain the account information such as the customer's current and prior account status.

Moreover, such a secure connection may be used by the central system 1263 to collect information regarding a customer's system. Such information includes, but is not limited to, error logs for use in diagnostics and troubleshooting. Some implementations of the invention allow a central system to collect other types of information, e.g., information about the usage of certain types of gaming software, revenue information regarding certain types of games and/or gaming machines, etc. Such information includes, but is not limited to, information regarding the revenue attributable to particular games at specific times of day, days of the week, etc. Such information may be obtained, at least in part, by reference to an accounting system of the gaming network(s), as described in U.S. patent application Ser. No. 11/225,407, by Wolf et al., entitled “METHODS AND DEVICES FOR MANAGING GAMING NETWORKS,” which has been incorporated herein by reference.

Automatic updates of a customer's SBG server may also be enabled. For example, central system 1263 may notify a local SBG server regarding new products and/or product updates. For example, central system 1263 may notify a local SBG server regarding updates of new gaming software, gaming software updates, peripheral updates, the status of current gaming software licenses, etc. In some implementations of the invention, central system 1263 may notify a local SBG server (or another device associated with a gaming establishment) that an additional theme-specific data set and/or updates for a previously-downloaded global payout set are available. Alternatively, such updates could be automatically provided to the local SBG server and downloaded to networked gaming machines.

After the local SBG server receives this information, it can identify relevant products of interest. For example, the local SBG server may identify gaming software that is currently in use (or at least licensed) by the relevant gaming entity and send a notification to one or more host devices, e.g., via email. If an update or a new software product is desired, it can be downloaded from the central system. Some relevant downloading methods are described elsewhere herein and in applications that have been incorporated herein by reference, e.g., in U.S. patent application Ser. No. 11/078,966. Similarly, a customer may choose to renew a gaming software license via a secure connection with central system 1263 in response to such a notification.

Secure communication links allow notifications to be sent securely from a local SBG server to host devices outside of a gaming establishment. For example, a local SBG server can be configured to transmit automatically generated email reports, text messages, etc., based on predetermined events that will sometimes be referred to herein as “triggers.” Such triggers can include, but are not limited to, the condition of a gaming machine door being open, cash box full, machine not responding, verification failure, etc.

In addition, providing secure connections between different gaming establishments can enable alternative implementations of the invention. For example, a number of gaming establishments, each with a relatively small number of gaming machines, may be owned and/or controlled by the same entity. In such situations, having secure communications between gaming establishments makes it possible for a gaming entity to use a single SBG server as an interface between central system 1263 and the gaming establishments.

The present invention may easily be implemented with SBG as future games may include updates to add the present invention. Furthermore, the success and/or failure of the new games may then be easily gauged from the relative performance data obtained from the gaming machines.

While embodiments and applications of this invention have been shown and described, it would be apparent to those skilled in the art having the benefit of this disclosure that many more modifications than mentioned above are possible without departing from the inventive concepts herein.

What is claimed is:

1. A system to determine relative performance data of a gaming machine, comprising:
a memory having a database stored therein;
a processor configured to perform the following operations:
obtain a relative performance value determined by confidential delta meter data and confidential gross meter data;
transform the relative performance value to a transformed performance value, wherein the transformed performance value is determined by multiplying the relative performance value with a previous transformed performance value; and
compile the transformed performance value in the database.

2. The system of claim 1, wherein the confidential delta meter data further comprises a current delta meter value and a previous delta meter value, wherein the current and previous delta meter values are obtained from the confidential gross meter data.

3. The system of claim 2, wherein the relative performance value is determined by dividing the current delta meter value by the previous delta meter value.

4. The system of claim 3, wherein if the previous delta meter value is equal to 0, obtain another previous delta meter value until the previous delta meter value is greater than 0.

5. The system of claim 2, wherein the current delta meter value is determined by a current confidential gross meter value subtracted from a previous confidential gross meter value.

6. The system of claim 1, wherein if the previous transformed performance value is equal to 0, obtain another previous transformed performance value until the previous transformed performance value is greater than 0.

7. The system of claim 2, wherein the previous delta meter value is obtained from a baseline gaming machine.

8. The system of claim 7, wherein if the previous delta meter value is equal to 0, obtain another previous delta meter value until the previous delta meter value is greater than 0.

9. The system of claim 1, wherein the previous transformed performance value is obtained from a baseline gaming machine.

10. The system of claim 9, wherein if the previous transformed performance value is equal to 0, obtain another previous transformed performance value until the previous transformed value is greater than 0.

11. The system of claim 1, further comprising a display to display a performance graph indicating the relative performance of the gaming machine, wherein the performance graph is a plot of the compiled transformed performance values.

12. A method for determining relative performance data of a gaming machine, comprising:
receiving a relative performance value determined by confidential delta meter data and confidential gross meter data;
transforming the relative performance value to a transformed performance value, wherein the transformed performance value is determined by multiplying the relative performance value with a previous transformed performance value; and
plotting the transformed performance value on a performance graph.

13. The method of claim 12, wherein the confidential delta meter data further comprises a current delta meter value and a previous delta meter value, wherein the current and previous delta meter values are obtained from the confidential gross meter data.

14. The method of claim 13, wherein the receiving further comprises determining the relative performance value by dividing the current delta meter value by the previous delta meter value.

15. The method of claim 14, wherein the receiving further comprises obtaining another previous delta meter value if the previous delta meter value is equal to 0.

16. The method of claim 15, further comprising repeating said obtaining until the previous delta meter value is greater than 0.

17. The method of claim 14, wherein the determining further comprises determining the current delta meter value by subtracting a current confidential gross meter data from a previous confidential gross meter data.

18. The method of claim 12, wherein the transforming further comprises obtaining another previous transformed performance value if the previous transformed performance value is equal to 0.

19. The method of claim 18, further comprising repeating said obtaining until the previous transformed performance value is greater than 0.

20. The method of claim 14, wherein the receiving further comprises obtaining the previous delta meter value calculated from a baseline gaming machine.

21. The method of claim 20, further comprising obtaining another previous delta meter value if the previous delta meter value is equal to 0.

22. The method of claim 21, further comprising repeating the obtaining until the previous delta meter value is greater than 0.

23. The method of claim 12, wherein the transforming further comprises obtaining the previous transformed performance value calculated from a baseline gaming machine.

24. The method of claim 23, further comprising obtaining another previous transformed performance value if the previous transformed performance value is equal to 0.

25. The method of claim 24, further comprising repeating the obtaining until the previous transformed performance value is greater than 0.

26. Logic encoded in one or more tangible media for execution and when executed operable to:
receive a relative performance value determined by confidential delta meter data and confidential gross meter data;
transform the performance value to a transformed performance value, wherein the transformed performance value is determined by multiplying the relative performance value with a previous transformed performance value; and
compile the transformed performance value in a database.

27. A method, comprising:
receiving raw meter data from a wager gaming machine; and
applying a first operation to the raw meter data to remove confidential data, thereby producing relative performance data.

28. The method of claim 27, wherein the confidential data comprise at least three gross meter values and at least two delta meter values.

29. The method of claim 28, wherein the first operation comprises dividing a first delta meter value by a second delta meter value to obtain a relative performance value.

30. The method of claim 29, wherein the dividing further comprises obtaining another second delta meter value if the second delta meter value is equal to 0.

31. The method of claim 30, further comprising repeating said obtaining until the obtained delta meter value is greater than 0.

32. The method of claim 29, wherein the dividing further comprises determining the first delta meter value by subtracting a first confidential gross meter value from a second confidential gross meter value.

33. The method of claim 27, further comprising applying a second operation to the relative performance data to produce a transformed performance value proportional to the raw meter value.

34. The method of claim 33, wherein the second operation comprises multiplying a relative performance value with a previous transformed performance value.

35. The method of claim 34, wherein the multiplying further comprises obtaining another previous transformed performance value if the previous transformed performance value is equal to 0.

36. The method of claim 35, further comprising repeating said obtaining until the previous transformed performance value is greater than 0.
